(19) United States
(12) Patent Application Publication
(10) Pub. No.: US 2015/0317430 A1
(43) Pub. Date: Nov. 5, 2015

(54) SYSTEMS AND METHODS FOR ANALYZING BIOLOGICAL PATHWAYS FOR THE PURPOSE OF MODELING DRUG EFFECTS, SIDE EFFECTS, AND INTERACTIONS

(71) Applicant: Advaita Corporation, Plymouth, MI (US)

(72) Inventor: Andrew Olson, Canton, MI (US)

(21) Appl. No.: 14/704,109

(22) Filed: May 5, 2015

Related U.S. Application Data
(60) Provisional application No. 61/988,605, filed on May 5, 2014.

(51) Int. Cl. G06F 19/12

(52) U.S. Cl. CPC G06F 19/12

(57) ABSTRACT

Systems and methods for analyzing biological pathways are described. The techniques describe herein may enable the selection of candidate drugs to be prioritized. The systems and methods described herein provide visualizations for the impact of a drug on a gene signaling pathway. A visualization may be based on gene signaling pathway topology information and a determined gene expression level equivalent value for a drug.

### RELATED APPLICATION

This application claims the benefit of U.S. Provisional Application No. 61/988,605, filed on May 5, 2014, which is incorporated by reference in its entirety.

### GOVERNMENT SUPPORT

This invention was made with government support under contract No. R42GM087013 awarded by the National Institutes of Health. The government has certain rights in the invention.

### TECHNICAL FIELD

This disclosure relates to biological pathways, and more particularly to techniques for analyzing biological pathways.

### BACKGROUND

Biological pathway diagrams illustrate the interaction of biological components. A gene signaling pathway may describe how genes interact with and regulate one another. Gene signaling pathway diagrams may be used to analyze genetically controlled mechanisms. Metabolic pathways may describe how various metabolic reactions take place in a given organism. Other types of biological pathways may describe other biological phenomena involving genes, proteins, metabolites, microRNAs and other natural or artificial entities that can have a biological effect. Gene expression class comparison studies may be used to identify genes that are differentially expressed between two phenotypes. Such phenotype comparisons may include diseased vs. control, treated vs. untreated, treated with drug A vs. treated with drug B, drug vs. placebo, dose comparisons, gene expression evolution over a time series or time A vs. time B comparisons, etc. By combining information included in biological pathways and gene expression studies relationships between genetically controlled mechanisms and the studied phenotypes may be analyzed.

Visualization tools may be used to analyze gene signaling pathways and information derived from gene expression studies. Typical visualization tools may be less than ideal for effectively displaying information included in gene signaling pathways and gene expression studies. It may be difficult for researchers to identify and analyze possible relationships between genetically controlled mechanisms and the phenotypes studied using typical visualization tools.

### SUMMARY

In general this disclosure describes techniques for analyzing biological pathways. In particular, this disclosure describes example techniques for analyzing the impact of a drug on one or more gene signaling pathways. It should be noted that although the examples described herein relate to determining the effects of a drug on one or more gene signaling pathways, the techniques may be more generally applied to analyzing the effects of any influence on one or more biological pathways. The systems and techniques described herein may enable researchers to more effectively identify and analyze possible relationships between genetically controlled mechanisms and influences.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating a gene signaling pathway diagram.

FIG. 2 is a conceptual diagram illustrating a gene signaling pathway diagram including gene expression data.

FIG. 3 is a block diagram illustrating an example system that may implement one or more techniques of this disclosure.

FIG. 4 is a block diagram illustrating an example of a computing device that may implement one or more techniques of this disclosure.

FIG. 5 is an example of a graphical user interface that may be provided by a computing device to implement one or more techniques of this disclosure.

FIG. 6 is an example of a graphical user interface that may be provided by a computing device to implement one or more techniques of this disclosure.

FIGS. 7A-7C are examples of graphical user interfaces that may be provided by a computing device to implement one or more techniques of this disclosure.

FIG. 8 is an example of a graphical user interface that may be provided by a computing device to implement one or more techniques of this disclosure.

FIG. 9 is an example of a graphical user interface that may be provided by a computing device to implement one or more techniques of this disclosure.

FIG. 10 is an example of a graphical user interface that may be provided by a computing device to implement one or more techniques of this disclosure.

### DETAILED DESCRIPTION

This disclosure describes example techniques for analyzing effects of an influence on one or more gene signaling pathways. The techniques described herein may be implemented in a device configured to provide graphical user interfaces to a user. The graphical user interfaces may enable a user to efficiently identify and analyze possible relationships between genetically controlled mechanisms and an influence, such as, for example a possible drug treatment.

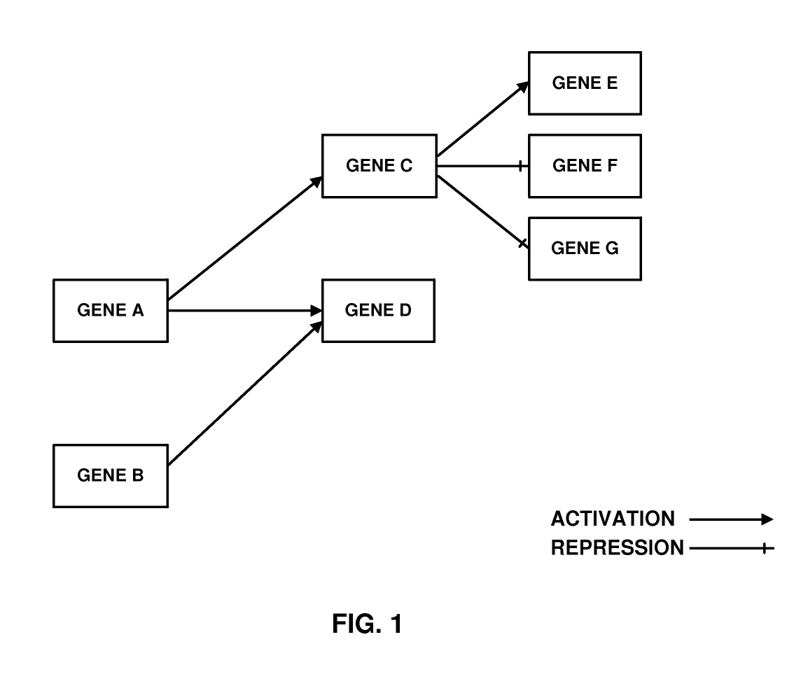

Gene signaling pathway diagrams illustrate how genes interact with and regulate one another and may be used to describe and analyze genetically controlled mechanisms. FIG. 1 is a conceptual diagram illustrating a gene signaling pathway diagram. The gene signaling pathway diagram illustrated in FIG. 1 shows activation and repression relationships in a pathway including gene A, gene B, gene C, gene D, gene E, gene F, and gene G. In FIG. 1, activation is indicated by edges terminated with an arrow whereas repression is indicated by edges terminated with a short line perpendicular on the edge. Other types of edges may be used to indicate other types of biological interactions. In the example illustrated in FIG. 1, a gene to the left of another gene in a pathway diagram may be described as upstream of the gene and a gene to the right of another gene in a pathway diagram may be described as downstream. For example, gene A is upstream of gene C and gene E is downstream of gene C. As further illustrated in FIG. 1, gene A activates gene C and gene D. In this manner, gene A may be described as having a direct downstream effect on gene C and gene D and an indirect downstream effect on any genes that gene C and gene D activate or repress (i.e., gene E, gene F, and gene G). As described in detail below, upstream and downstream relationship may be used to determine a perturbation associated with a gene.

It should be noted that the gene signaling pathway illustrated in FIG. 1 represents a simplified gene signaling pathway and a typical gene signaling pathway may include dozens or hundreds of genes and may illustrate several possible interactions, including, for example, one or more of the following interactions: phosphorylation, dephosphorylation, ubiquitination, glycosylation, methylation, activation, inhibition, indirect effects, state change, binding/association, dissociation, expression, microRNA activity and/or activation or repression through other mechanisms. Interactions may also include protein-protein interactions, gene expression relations, catalytic molecular interactions and/or enzyme-enzyme interactions. Example gene signaling pathways are included in the KEGG: Kyoto Encyclopedia of Genes and Genomes, the Reactome pathway database, and databases maintained by BioCarta. It should be noted that a particular gene may be included in multiple pathways. That is, many systems share common genes (albeit with possibly different roles). It should be noted that although different pathways may include different descriptive conventions, the techniques described herein are generally applicable to all types of pathways and are not limited to a particular type of pathway description.

Gene expression class comparison studies may be used to identify genes as differentially expressed (DE) between sample groups. In one example, microarray measurements may be used to determine expression levels of genes in an individual. Gene expression class comparison studies may compare the expression levels of genes of individuals included in one sample group to the expression levels of genes of individuals included in another sample group (e.g. normal and diseased, drug A vs drug B, treated vs non-treated, etc.). A list of DE genes together with their estimated expression changes between the sample groups may be derived from expression level data. It should be noted that due to the large number of genes included in the human genome (i.e., approximately 30,000), normal variances in expression levels between individuals, and the reliability of microarray measurements, different statistical analysis techniques may be used to derive distinct lists of DE genes and expression level changes from the same data. For example, one analysis technique may identify 50 DE genes from a data set and another analysis technique may identify 100 distinct DE genes from the data set. The techniques described herein are not limited to a particular technique deriving a list of DE gene and expression level changes. It should be noted that differentially expressed genes exceeding a threshold variance between groups may be referred to as Significant Differential Expression (SDE) and in some cases the term DE gene and SDE gene are used interchangeably. In some cases, it may be valuable to perform an analysis that includes the measurements for all genes, as well as other types of measurements including protein levels, microRNAs, etc. As used herein, the term DE gene denotes an arbitrary set of measurements that may include any, all or any combination of the following: a set of DE genes, a set of SDE, the set of all genes, proteomics, miRNA, metabolite or other types of related data.

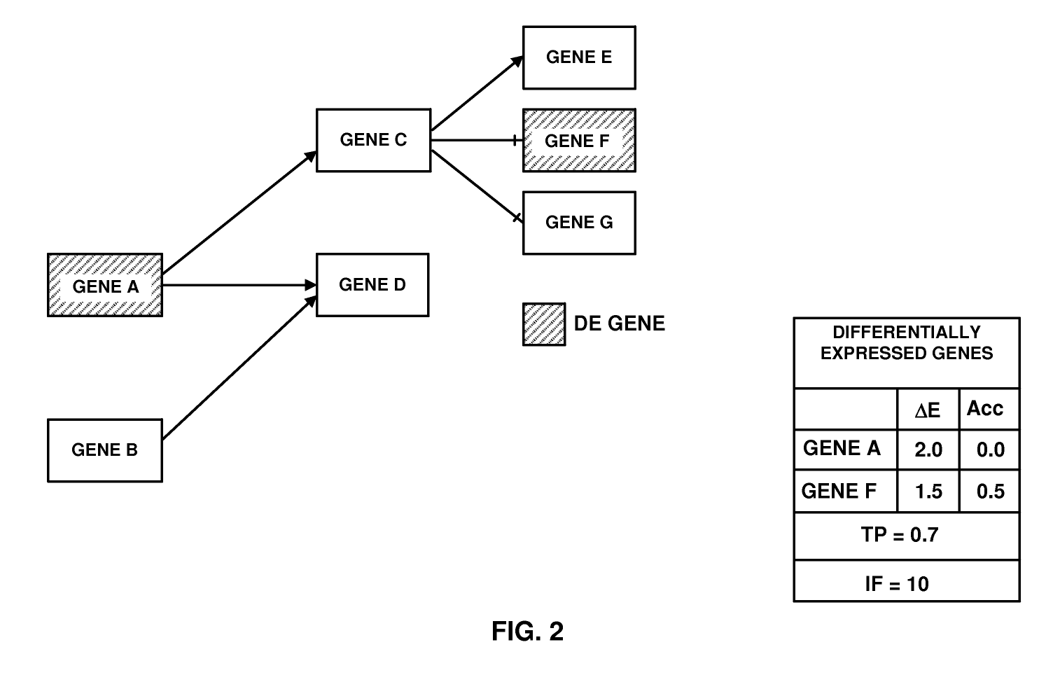

In addition to displaying downstream relationships, a gene signaling pathway diagram may include gene expression data from a gene expression class comparison study. FIG. 2 is a conceptual diagram illustrating a gene signaling pathway diagram including gene expression data. As illustrated in FIG. 2, gene A and gene F are illustrated as being DE genes based an analysis of a gene expression class comparison study. For example, gene A and gene F may represent DE genes derived from expression data from a sample group known to have a particular type of cancer compared to expression data from a sample group known not to have that particular type of cancer.

In addition to identifying a gene in a signaling pathway as a DE gene, additional information may be included within and/or in addition to a gene signaling pathway diagram to enable researchers to analyze the effects one or more DE genes may have on the interaction of biological components. Draghici et al. “A systems biology approach to pathway level analysis” Genome Research, 17 (2007): Pages 1537-1545, Tarca et al. “A Novel Signaling Pathway Impact Analysis.” Bioinformatics, 25. 1 (2009): Pages 75-82 and Voichita “Towards Personalized Medicine Using Systems Biology And Machine Learning,” (2013) Wayne State University Dissertations, dissertation 805, each of which are incorporated by reference in their respective entirety, describe techniques for determining the effect genes may have on a particular pathway. In particular, Draghici, Tarca and Voichita describe techniques for analyzing data from a gene expression class comparison study within the context of pathway topology. For example, Draghici, Tarca and Voichita consider the potential effects a DE gene has on downstream genes.

Draghici et al. describes techniques for calculating an impact factor (IF) of all DE genes in a pathway Pᵢ, wherein an impact factor quantifies: (i) type and position of each of the differentially expressed genes in a pathway; (ii) the magnitude of their expression change; and (iii) the type of interaction between all genes in the pathway. In one example, IF(Pᵢ) is determined according to the following equation:

$$IF ( {P}_{i} ) = log ( \frac{1}{{p}_{i}} ) + PF ( {P}_{i} )$$

where pᵢ is the probability of retrieving the same number of DE genes in pathway, Pᵢ, by chance and PF(Pᵢ) is a functional term that depends on the identities of specific DE genes as well as on the interactions described by pathway Pᵢ (e.g., pathway topology). In one example, PF(Pᵢ) is based on the sum of the perturbation factors for all genes in a pathway, Pi. In the example described in Draghici et al., PF(Pᵢ) may be determined according to the following equation:

$$PF ( {P}_{i} ) = \frac{{\sum }_{g ∈ {P}_{i}} \vert PF ( g ) \vert}{\overline{\vert Δ E \vert} \cdot {N}_{de} ( {P}_{i} )}$$

where PF(g) is the perturbation factor of a gene g. In one example, the perturbation factor of a gene g is the sum of the change in the expression level of gene g and a perturbation term based on genes upstream of gene g. In one example, the numerator in the equation above may be referred to as the total perturbation (TP). In the equation above, the denominator term may normalize the total perturbation, where N_{de(Pi)} is the number of DE genes on the given pathway Pᵢ and |ΔE| is a mean fold change over all DE genes. In this manner, an impact factor (IF) of a pathway, Pi, captures the impact of all DE genes within the pathway. Further, in addition to determining an impact factor (IF) of all DE genes in a pathway Pᵢ, the accumulated perturbation (i.e., Acc(g)) for a gene may be determined, where the accumulated perturbation is the change in expression level of a gene (i.e., ΔE(g)) subtracted from the perturbation factor of a gene (i.e., PF(g)).

As illustrated in FIG. 2, the change in expression level of a gene (ΔE) and the accumulated perturbation (Acc) for each of gene A and gene F is displayed and the total perturbation (TP) and the impact factor (IF) of the pathway are illustrated in addition to the pathway diagram. In this manner, the diagram illustrated in FIG. 2 may enable researchers to analyze the effects one or more DE genes may have on the interaction of biological components. Visualization tools, such as those described in U.S. Pat. No. 8,068,994, which is incorporated by reference herein in its entirety, may be used to analyze gene signaling pathways and information included in gene expression studies.

Current visualization tools are limited to including gene signaling pathway information and information included in gene expression studies. Current visualization tools do not efficiently enable researchers to analyze how an influence, such as, for example, a drug, may impact biological pathways. The techniques described herein may be used to enable researchers to efficiently analyze the effects of an influence on one or more gene signaling pathways. In one example, the techniques described herein may enable researchers to efficiently analyze the effects of an influence on one or more gene signaling pathways including one or more DE genes.

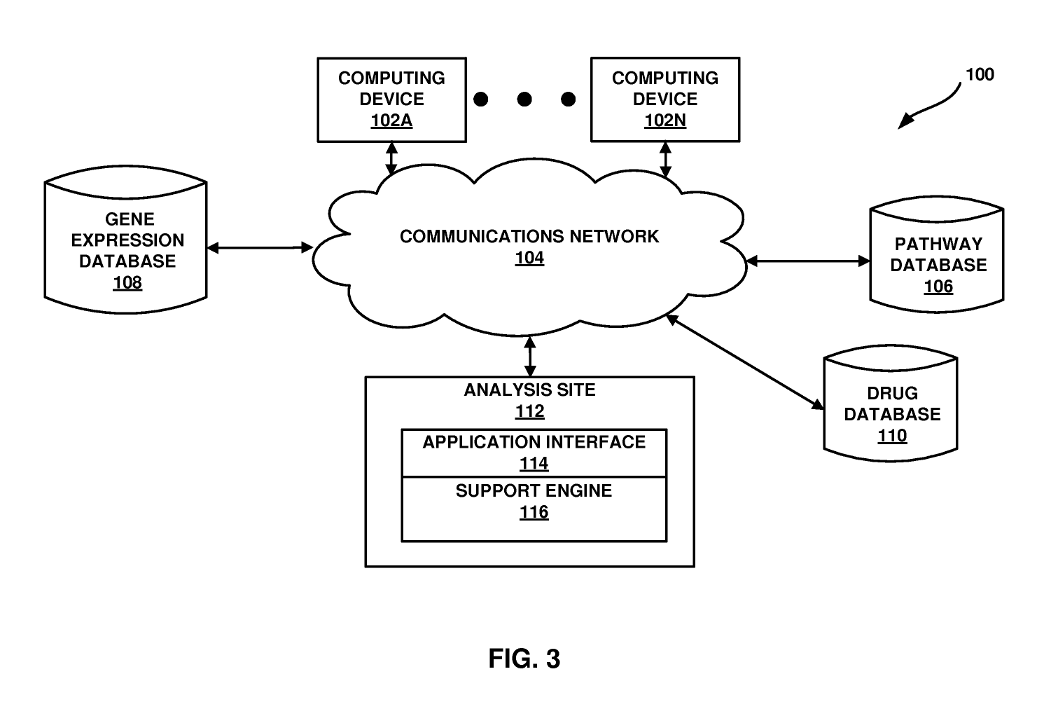

FIG. 3 is a block diagram illustrating an example system that may implement one or more techniques of this disclosure. System 100 may be configured to analyze biological pathways in accordance with the techniques described herein. In the example illustrated in FIG. 3, system 100 includes one or more computing devices 102A-102N, communications network 104, pathway database 106, gene expression database 108, drug database 110, and analysis site 112. Analysis site 112 may include application interfaces 114 and support engine 116. System 100 may include software modules operating on one or more servers. Software modules may be stored in a memory and executed by a processor. Servers may include one or more processors and a plurality of internal and/or external memory devices. Examples of memory devices include file servers, network attached storage (NAS) devices, a local disk drive, or any other type of device or storage medium capable of storing data. Storage medium may include Blu-ray discs, DVDs, CD-ROMs, flash memory, or any other suitable digital storage media. When the techniques described herein are implemented partially in software, a device may store instructions for the software in a suitable, non-transitory computer-readable medium and execute the instructions in hardware using one or more processors.

System 100 represents an example of a system that may be configured to enable users of computing devices 102A-102N to analyze biological pathways. Computing devices 102A-102N may include any device configured to transmit data to and receive data from communication network 104. For example, computing devices 102A-102N may be equipped for wired and/or wireless communications and may include desktop or laptop computers, mobile devices, tablet computers, smartphones, cellular telephones, set top boxes, and personal gaming devices.

Communications network 104 may comprise any combination of wireless and/or wired communication media. Communication network 104 may include routers, switches, base stations, or any other equipment that may be used to facilitate communication between various devices and sites. Communication network 104 may form part of a packet-based network, such as a local area network, a wide-area network, or a global network such as the Internet. Communication network 104 may operate according to one or more communication protocols, such as, for example, a Global System Mobile Communications (GSM) standard, a code division multiple access (CDMA) standard, a 3rd Generation Partnership Project (3GPP) standard, an Internet Protocol (IP) standard, a Wireless Application Protocol (WAP) standard, and/or an IEEE standard, such as, one or more of the 802.11 standards, as well as various combinations thereof.

As illustrated in FIG. 3, pathway database 106, gene expression database 108, and drug database 110 are connected to communications network 104. Each of pathway database 106, gene expression database 108, and drug database 110 may respectively include any and all combinations of the memory devices described above. Each of pathway database 106, differential gene expression database 108, and drug database 110 may store information associated with the operation of system 100.

Pathway database 106 may store data associated with biological pathways. For example, pathway database 106 may include a list of genes included in a pathway, information about genes included in a pathway, pathway topology information, and information regarding the interactions of genes in a pathway. In one example, pathway database 106 may include data associated with gene signaling pathways, including, for example, pathways described in the KEGG: Kyoto Encyclopedia of Genes and Genomes, the Reactome pathway database, and/or the databases maintained by BioCarta. As described above, a gene signaling pathway may include dozens of genes and may illustrate several possible interactions, including, for example: phosphorylation, dephosphorylation, ubiquitination, glycosylation, methylation, activation, inhibition, indirect effects, state change, binding/association, dissociation, expression, and/or repression. In one example, pathway database 106 may include pathway data from diverse sources.

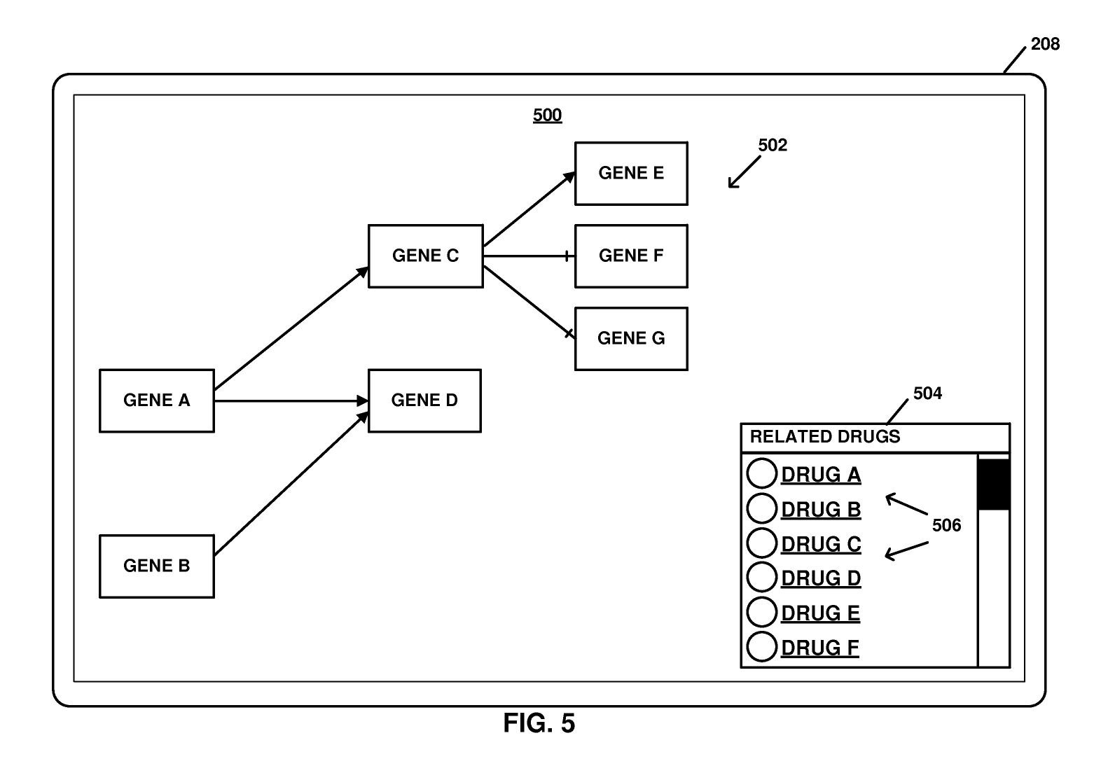

Analysis site 112 and/or computing devices 102A-102N may use information included in pathway database 106 to determine the effect on an influence on a pathway and/or to generate graphical user interfaces including pathway diagrams. As described in detail below with respect to FIGS. 5-10, graphical user interfaces including pathway diagrams may enable a user of a computing device to analyze possible relationships between genetically controlled mechanisms and influences.

Gene expression database 108 may store data associated with gene expression data. As described above, expression levels of genes in an individual may be derived from measurements, such as, for example, microarray measurements. Based on expression level measurements, DE genes may be identified between groups. Gene expression database 108 may include data associated with gene expression measurements and/or data derived from gene expression measurements, including, for example, lists of DE genes derived from gene expression measurements and associated changes in expression levels (i.e., ΔE(g)). In one example, gene expression database 108 may include electronic copies of published articles describing experiments and techniques for determining DE genes. In one example, gene expression database 108 may include one or more standardized sets of data from gene expression class comparison studies.

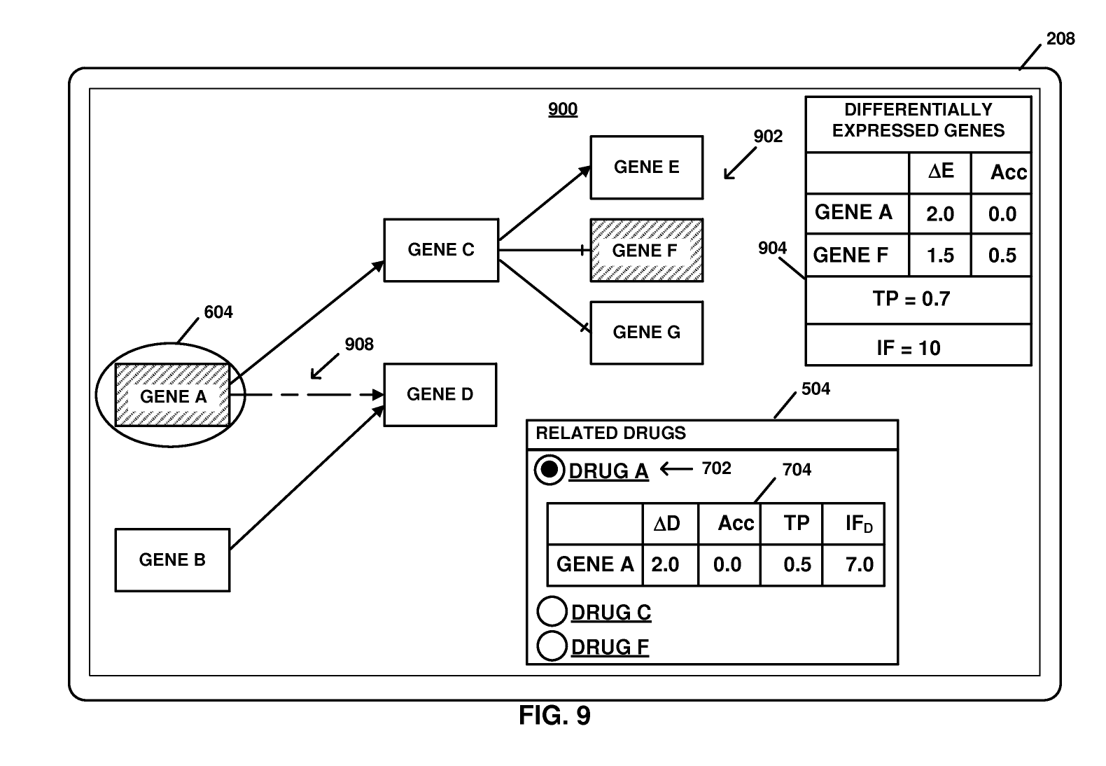

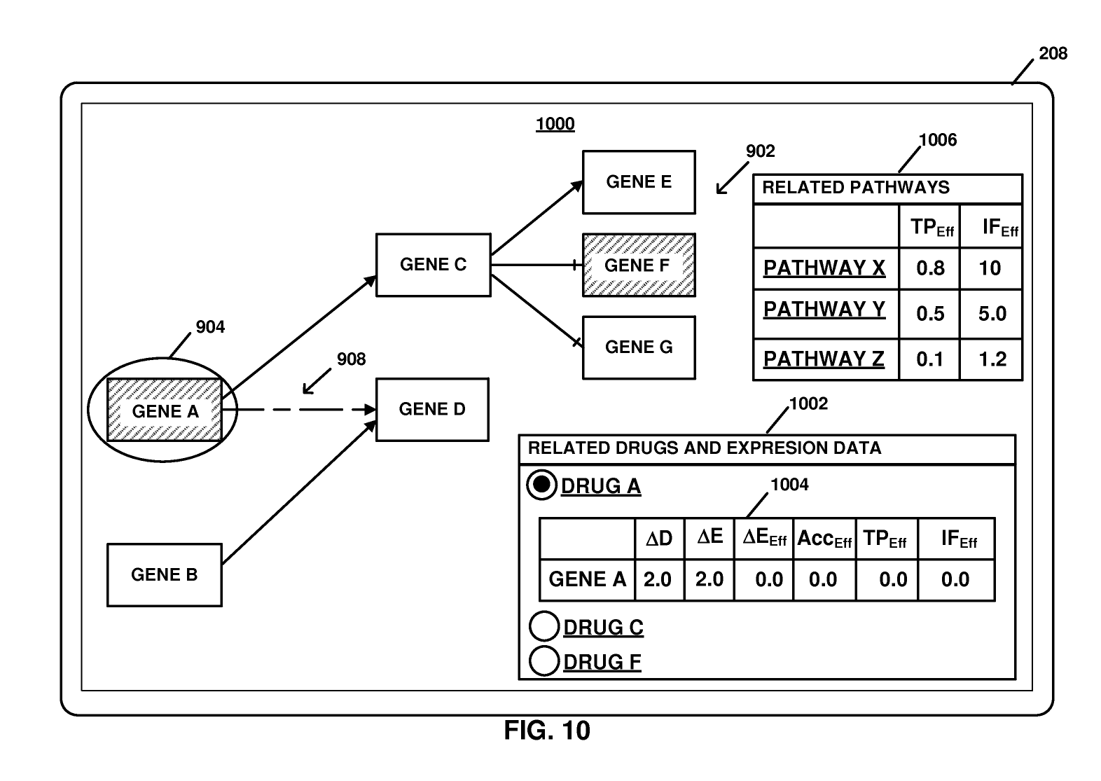

Analysis site 112 and/or computing devices 102A-102N may use information included in gene expression database 108 to determine DE genes and/or changes in expression levels. As described in detail below, analysis site 112 and/or computing devices 102A-102N may use information included in gene expression database 108 to generate graphical user interfaces including DE gene expression information. As described in detail below with respect to FIGS. 9-10, graphical user interfaces including DE gene expression information may enable a user of a computing device to analyze possible relationships between genetically controlled mechanisms and influences.

Drug database 110 may be configured to store information associated with drugs. In one example, a drug may be defined as any influence on a biological system. In one example, a drug may be defined as a synthetic compound. In one example, a drug may include a synthetic composition or a biologic composition (e.g., peptides, hormones, micro RNA, etc.). In one example, a drug may include a vector (e.g., recombinant viruses, DNA-complexes) and a DNA that incorporates a therapeutic protein (gene therapy). Drug database 110 may include one or more of targeted pathways, targeted genes, mechanisms of action, formula, mass, molecular weight, chemical structure, classification, and/or activity data associated with a drug. Further, drug database 110 may include remarks associated with a drug. Drug database 110 may include one or more commercially and/or publically maintained drug databases including, for example, PubChem, DrugBank, and LigandBox. In one example, drug database 110 may include drug data provided in KEGG (Kyoto Encyclopedia of Genes and Genomes).

Analysis site 112 and/or computing devices 102A-102N may use information included in drug database 110 to model the effect that a drug may have on a biological pathway. As described above, a change in expression level of a gene (i.e., ΔE(g)) may be derived from gene expression class comparison studies and a change in expression level of a gene may be used to determine an impact factor (IF) for a pathway. In one example, drug database 110 may include data which may be used to represent the effects of a drug as an expression level change equivalent, where a drug expression level change equivalent for a gene g is referred to as ΔD(g).

In one example, ΔD(g) may be determined by comparing known drug effects to gene expression class comparison studies. For example, referring to the example illustrated in FIG. 2, if a drug is known to limit the output of gene A and a gene expression class comparison study indicates an expression value change that causes the output of gene A to be limited (e.g., ΔE(g)=2.0), ΔD(g) may be set to the value of expression value change derived from the class comparison study (i.e., ΔD(g)=2.0). For example, in the MAPK Signaling pathway, drug Gevokizumab is known to bind with the protein output from IL1, thus blocking the signal to IL1R and drug Anakinra is known to block the signal to IL1R by binding to the receptor itself. In this example, if a gene expression class comparison study indicates an expression level change of either IL1 or IL1R that causes the signal from IL1 to IL1R be blocked, ΔD(g) for Gevokizumab and Anakinra may be determined based on the determined expression level changes. It should be noted that in this case the IL1 is a ligand, but in gene expression signaling it may be consider generically as a gene.

Further, in another example, ΔD(g) may be determined by measuring expression level changes from an individual before and after receiving a drug or by measuring expression level changes between a group receiving a drug and a group not receiving a drug. That is, ΔD(g) may be determined based on an observed expression value of drug treatment study. Kovalenko et al. “1,25 dihydroxyvitamin D-mediated orchestration of anticancer, transcript-level effects in the immortalized, non-transformed prostate epithelial cell line, RWPE1.” BMC Genomics 2010, 11:26 which is incorporated by reference in its entirety describes treating a prostate cancer cell line with an active form of vitamin D to model its effect on gene expression. Based on data included in this study a ΔD(g) for vitamin D can be determined. In one example, ΔD(g) may be determined as equal to measured expression values. In other examples, ΔD(g) may be determined as equal to normalized measured expression values.

As described in further detail below, analysis site 112 and/or computing devices 102A-102N may use a determined ΔD(g) to determine the impact factor of a drug on a pathway (e.g., IF_{D}). In one example, a determined ΔD(g) may be substituted for the ΔE(g) value in the impact factor equations described above. That is, by representing the effects of a drug as a change in gene expression value equivalent, equations quantifying one or more of (i) type and position of differentially expressed genes in a pathway; (ii) the magnitude of their expression change; and (iii) the type of interaction between all genes in the pathway may be used to determine the impact factor of a drug on a pathway. Further, in one example, a ΔD(g) value may be used to modify a ΔE(g) value in the impact factor equations described above. For example, if a ΔE(g)=2.0 and a ΔD(g)=−1.0 a value of 1.0 may be used for ΔE(g) in the equations above. In this manner, pathway data, gene expression data, and drug data may be combined to predict the effect of a drug on a biological system. In one example, drug database 110 may include a ΔD(g) value for one or more drugs included in drug database 110.

As described in detail below, analysis site 112 and/or computing devices 102A-102N may use information included in pathway database 106, gene expression database 108, and drug database 110 to generate graphical user interfaces including biological pathway diagrams and associated drug information and/or graphical user interfaces including biological pathway diagrams, associated drug information, and gene expression data. As described in detail below with respect to FIGS. 5-10, graphical user interfaces including biological pathway diagrams and associated drug information may enable a user of a computing device to analyze possible relationships between genetically controlled mechanisms and drugs.

As illustrated in FIG. 3, analysis site 112 is connected to communications network 104. Analysis site 112 may be configured to provide data to computing devices 102A-102N. In one example, computing devices 102A-102N may process information provided by analysis site 112 in a manner that enables a user of a computing device to analyze a biological pathway. In one example, analysis site 112 includes a server. In the example illustrated in FIG. 3, analysis site 112 includes application interface 114 and support engine 116. Application interface 114 and support engine 116 may be implemented as any of a variety of suitable circuitry, such as one or more microprocessors, digital signal processors (DSPs), application specific integrated circuits (ASICs), field programmable gate arrays (FPGAs), discrete logic, software, software modules, hardware, firmware or any combinations thereof.

In one example, application interface 114, support engine 116, and modules thereof may be implemented using one or more programming languages. Examples of programming languages include Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, JavaScript, Jini™, C, C++, Perl, Python, UNIX Shell, Visual Basic or Visual Basic Script, Virtual Reality Markup Language (VRML), ColdFusion™ and other compilers, assemblers, and interpreters.

Application interface 114 may be configured to provide an interface between analysis site 112 and one or more of computing devices 102A-102N. For example, as described in detail below, application interface 112 may provide one or more graphical user interfaces (GUIs) to computing devices 102A-102N. It should be noted that providing a graphical user interface to a computing device may include providing data to a computing device such that a computing device may generate a graphical user interface. Support engine 116 may be configured to support the operations of analysis site 112. For example, as described in detail below, support engine 116 may receive a request from one or more computing devices for a gene pathway and drug information and provide requested information to a computing device. For example, support engine 116 may be configured to filter and/or search for pathways based on drugs associated with a pathway. Further, in one example, support engine may be configured to determine an impact factor for a drug, IF_{D}.

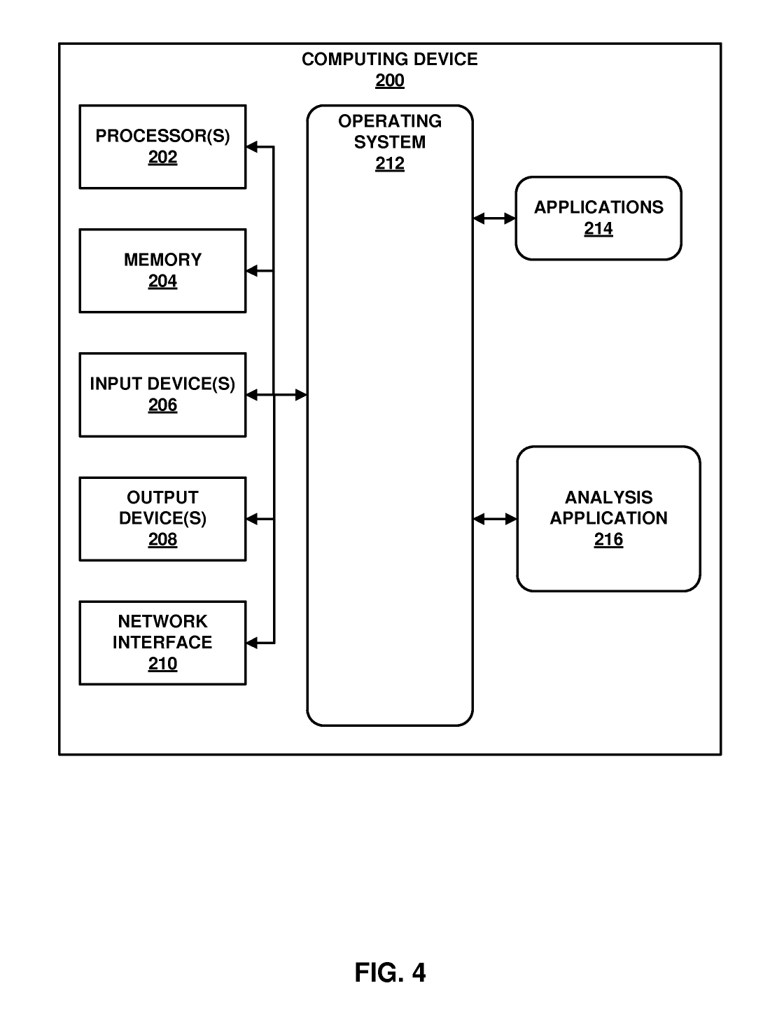

FIG. 4 is a block diagram illustrating an example of a computing device that may implement one or more techniques of this disclosure. Computing device 200 is an example of a computing device that may execute one or more applications, including analysis application 216. Computing device 200 may include or be part of a portable computing device (e.g., a mobile phone, netbook, laptop, personal data assistant (PDA), or tablet device) or a stationary computer (e.g., a desktop computer, or set-top box). Computing device 200 includes processor(s) 202, memory 204, input device(s) 206, output device(s) 208, and network interface 210.

Each of processor(s) 202, memory 204, input device(s) 206, output device(s) 208, and network interface 210 may be interconnected (physically, communicatively, and/or operatively) for inter-component communications. Operating system 212, applications 214, and analysis application 216 may be executable by computing device 200. It should be noted that although example computing device 200 is illustrated as having distinct functional blocks, such an illustration is for descriptive purposes and does not limit computing device 200 to a particular hardware architecture. Functions of computing device 200 may be realized using any combination of hardware, firmware and/or software implementations.

Processor(s) 202 may be configured to implement functionality and/or process instructions for execution in computing device 200. Processor(s) 202 may be capable of retrieving and processing instructions, code, and/or data structures for implementing one or more of the techniques described herein. Instructions may be stored on a computer readable medium, such as memory 204. Processor(s) 202 may be digital signal processors (DSPs), general purpose microprocessors, application specific integrated circuits (ASICs), field programmable logic arrays (FPGAs), or other equivalent integrated or discrete logic circuitry.

Memory 204 may be configured to store information that may be used by computing device 200 during operation. As described above, memory 204 may be used to store program instructions for execution by processor(s) 202 and may be used by software or applications running on computing device 200 to temporarily store information during program execution. For example, memory 204 may store instructions associated with operating system 212, applications 214, and analysis application 216 or components thereof, and/or memory 204 may store information associated with the execution of operating system 212, applications 214, and analysis application 216.

Memory 204 may be described as a non-transitory or tangible computer-readable storage medium. In some examples, memory 204 may provide temporary memory and/or long-term storage. In some examples, memory 204 or portions thereof may be described as volatile memory, i.e., in some cases memory 204 may not maintain stored contents when computing device 200 is powered down. Examples of volatile memories include random access memories (RAM), dynamic random access memories (DRAM), and static random access memories (SRAM). In some examples, memory 204 or portions thereof may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Input device(s) 206 may be configured to receive input from a user operating computing device 200. Input from a user may be generated as part of a user running one or more software applications, such as analysis application 216. Input device(s) 206 may include a touch-sensitive screen, track pad, track point, mouse, a keyboard, a microphone, video camera, or any other type of device configured to receive input from a user.

Output device(s) 208 may be configured to provide output to a user operating computing device 200. Output may tactile, audio, or visual output generated as part of a user running one or more software applications, such as applications 214 and/or analysis application 216. Output device(s) 210 may include a touch-sensitive screen, sound card, a video graphics adapter card, or any other type of device for converting a signal into an appropriate form understandable to humans or machines. Additional examples of an output device(s) 210 may include a speaker, a cathode ray tube (CRT) monitor, a liquid crystal display (LCD), or any other type of device that can provide output to a user.

Network interface 210 may be configured to enable computing device 200 to communicate with external devices via one or more networks. Network interface 210 may be a network interface card, such as an Ethernet card, an optical transceiver, a radio frequency transceiver, or any other type of device that can send and receive information. Network interface 210 may be configured to operate according to one or more communication protocols.

Operating system 212 may be configured to facilitate the interaction of applications, such as applications 214 and analysis application 216, with processor(s) 202, memory 204, input device(s) 206, output device(s) 208, network interface 210 and other hardware components of computing device 200. Operating system 212 may be an operating system designed to be installed on laptops and desktops. For example, operating system 212 may be a Windows operating system, Linux, or Mac OS. In another example, if computing device 200 is a mobile device, such as a smartphone or a tablet, operating system 212 may be one of Android, iOS or a Windows mobile operating system.

Applications 214 may be any application implemented within or executed by computing device 200 and may be implemented or contained within, operable by, executed by, and/or be operatively/communicatively coupled to components of computing device 200, e.g., processor(s) 202, memory 204, and network interface 210. Applications 214 may include instructions that may cause processor(s) 202 of computing device 200 to perform particular functions. Applications 214 may include algorithms that are implemented in computer programming statements, such as, for loops, while-loops, if-statements, do-loops, etc.

Analysis application 216 may be an application that allows computing device 200 to perform functionality associated with system 100. In one example, analysis application 216 may be a web browser, such as, for example, Internet Explorer of Google Chrome and any associated supporting software modules (e.g., plugins). In one example, analysis application 216 may be a standalone application. It should be noted that techniques described herein may be performed by analysis application 216 and/or analysis site 112. In one example analysis application 216 may retrieve information from databases to determine an IF_{D} value. In another example, support engine 116 may determine an IF_{D} value and analysis application 216 may retrieve the IF_{D} from support engine 116. It should be noted that the techniques described herein are not limited to a particular system architecture and may be realized using any combination of hardware, firmware and/or software implementations.

As described above, analysis site 112 and/or computing devices 102A-102N may process data included in pathway database 106, gene expression database 108, and drug database 110 to generate graphical user interfaces. FIGS. 5-10 illustrate examples of graphical user interfaces that may be provided by a computing device to implement one or more techniques of this disclosure. In the examples illustrated in FIGS. 5-10, graphical user interfaces are illustrated as being displayed using output device 208.

FIG. 5 is an example of a graphical user interface that may be provided by a computing device to implement one or more techniques of this disclosure. Graphical user interface 500 is an example of a graphical user interface that enables a user to select and display a list of drugs for a particular gene included in a pathway. In one example, analysis site 112 may provide graphical user interface 500 to one of computing devices 102A-102N upon a user of a computing device selecting a pathway included in pathway database 106. In one example, analysis site 112 may receive a search query and may provide a list of results including pathways to a computing device from which a pathway selection may be made. For example, a user may wish to search for pathways based on whether a particular drug is known to act on the pathway.

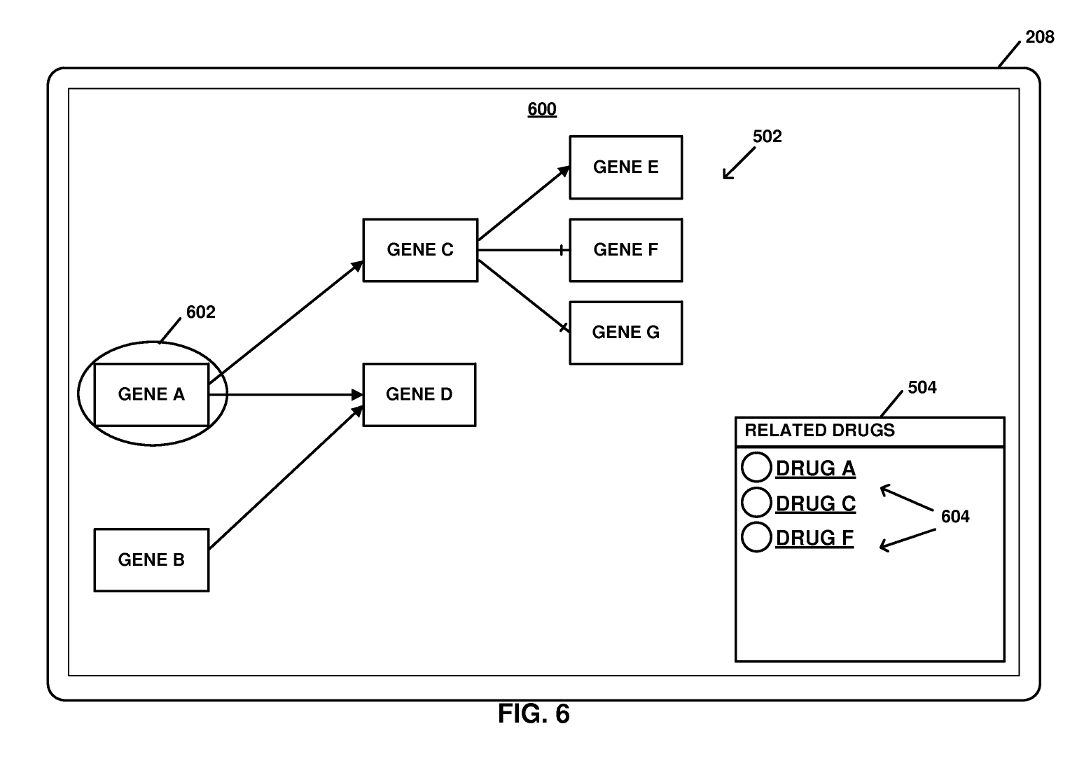

As illustrated in FIG. 5, graphical user interface 500 includes pathway diagram 502 and related drug window 504, where related drug window 504 includes a list of drugs 506 and a respective selection field and a hyperlink for each drug name included in the list. As described above, biological pathway diagrams illustrate how biological components interact with and regulate one another. Pathway diagram 502 represent an example of a biological pathway diagram that may be displayed to a user. In the example illustrated in FIG. 5, pathway diagram 502 illustrates the gene signaling pathway described above with respect to FIG. 1 and each gene included in pathway diagram 502 may be selectable by a user of a computing device. That is, a user may use an input device, such as, for example, input device(s) 206 to select one or more of the genes included in pathway 502. Upon selection of a gene, additional graphical user interfaces may be generated. Examples of graphical user interfaces that may be generated upon selection of a gene are described below with respected to FIGS. 6-10.

In the example illustrated in FIG. 5, related drug window 504 includes a list of drugs known to act on one or more genes included in pathway 502. As described above, dozens, hundreds, or more genes may be included in a pathway. Thus, the number of drugs known to act on one or more genes in a pathway may include dozens to hundreds of drugs. In this case, it may not be practical or desirable to display all of the drugs known to act on one or more genes included in pathway 502 simultaneously. In the example illustrated in FIG. 5, related drug window 504 includes a scroll bar that enables a user to display additional drugs not initially displayed in graphical user interface 500. Further, analysis site 112 may be configured to sort and/or filter a list of drugs included in related drug window 504. For example, analysis site 112 may be configured to list drugs in order of popularity.

In one example analysis site 112 may be configured to sort and/or filter drugs based on user specified criteria. For example, a user of a computing device may wish to filter a list of drugs included in related drugs window 504 based on one or more of a mechanism of action, drug interactions, availability, administration (e.g., injection vs. oral) and/or cost. In other examples, a user of a computing device may be able to filter drugs based on any and all combinations of classification, mechanism of action, activity, formula, or structure. In one example, drugs may be filtered and/or prioritized using intended targets and/or functional drug hierarchies (e.g., BRITE). In one example, analysis site 112 may receive a pathway selection and sorting/filtering criteria from a computing device and generate graphical user interface 500 based on the pathway selection and sorting/filtering criteria.

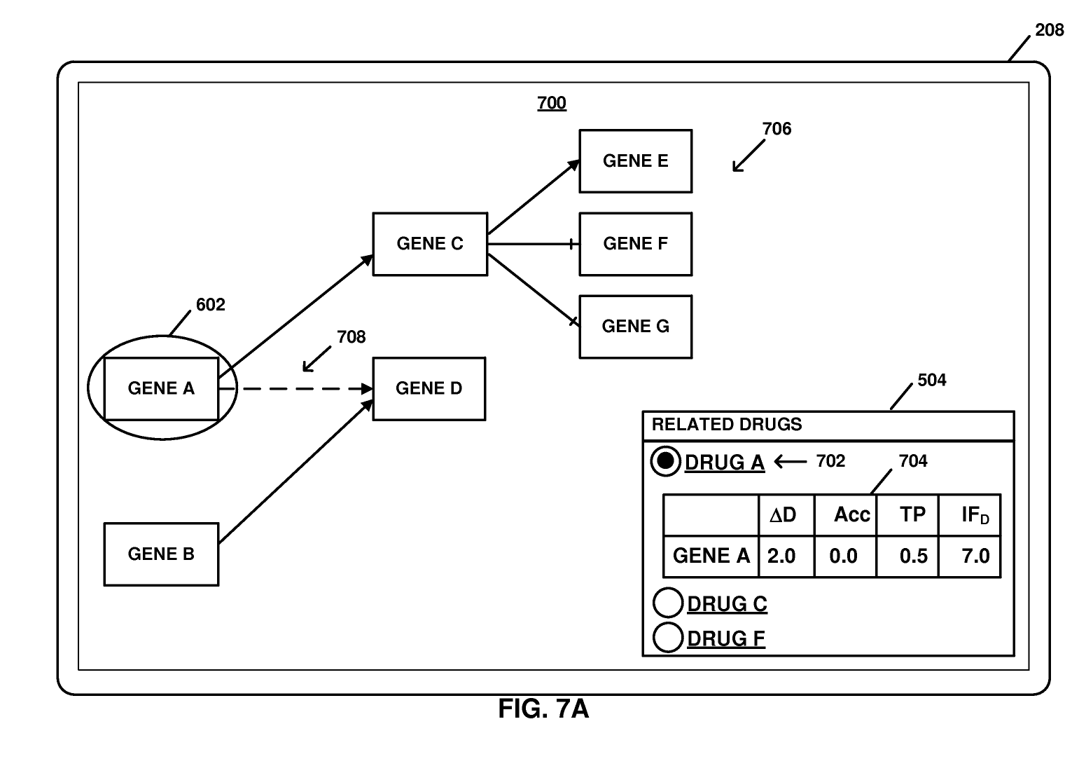

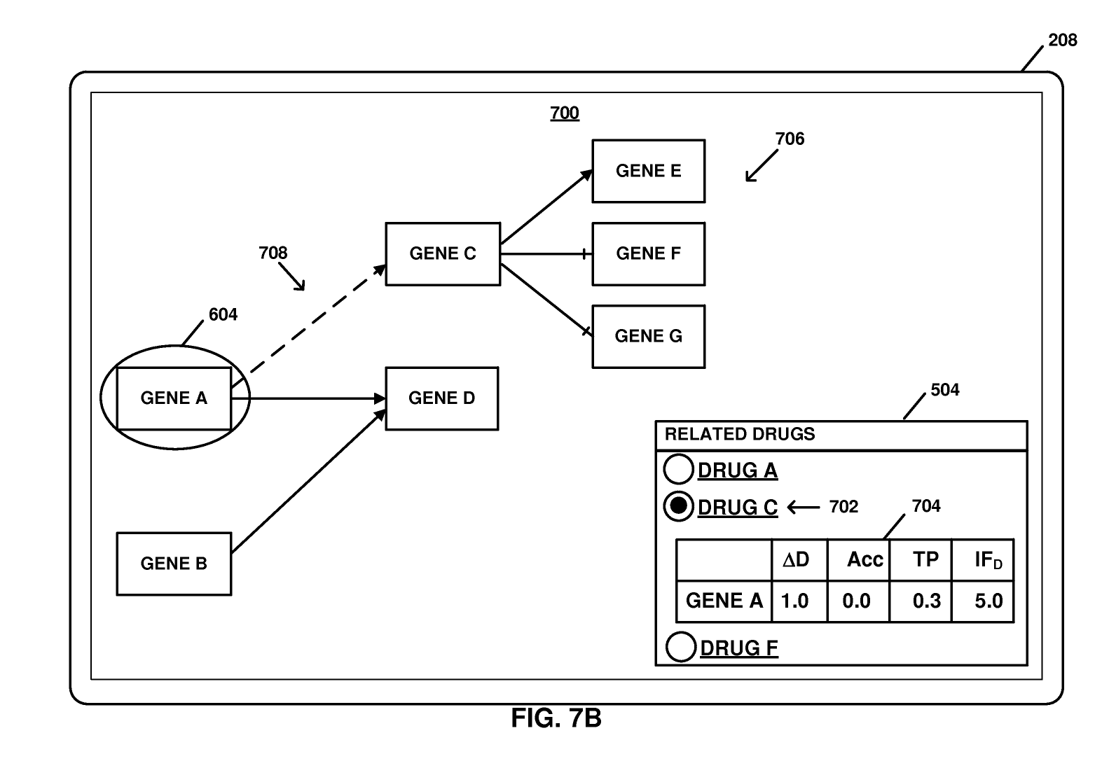

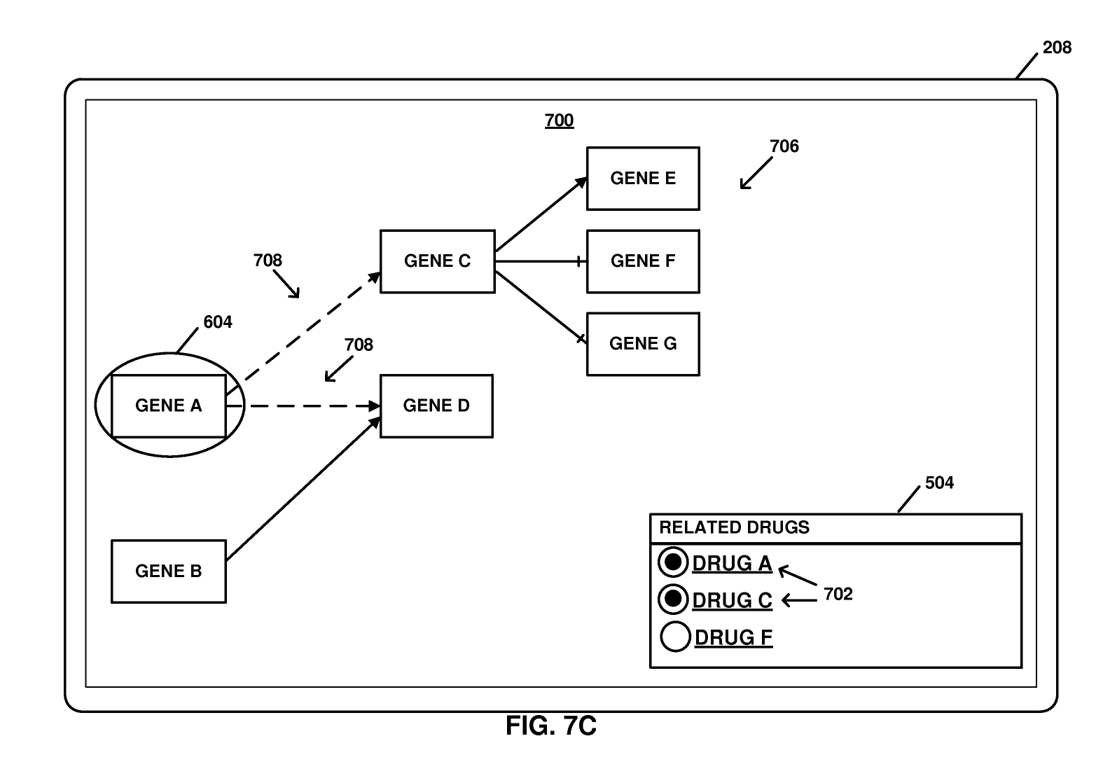

In the example illustrated in FIG. 5, upon a user activating a hyperlink associated with a drug name, detailed information associated with the drug may be provided. For example, a pop-up window including the chemical formulation of the drug may be generated. In the example illustrated in FIG. 5, a user may select a drug by activating a radio button. Upon selection of a drug, additional graphical user interfaces may be generated. Examples of graphical user interfaces that may be generated upon selection of a drug are described below with respected to FIGS. 7-10.

As described above, upon selection of a gene in graphical user interface 500, analysis site 112 and/or computing devices 102A-102N may generate graphical user interfaces based on a selected gene. FIG. 6 is an example of a graphical user interface that may be provided by a computing device to implement one or more techniques of this disclosure. Graphical user interface 600 is an example of a graphical user interface that enables a user to view a list of drugs acting on a particular gene in a pathway. In the example illustrated in FIG. 6, graphical user interface 600 includes a selected gene 602 included in pathway diagram 502 and filtered list of drugs 604 in related drug window 504. As illustrated in FIG. 6, selected gene 602 (i.e., gene A) includes a visual indicator (i.e., ellipse outline) identifying a selected drug. As further illustrated in FIG. 6, the related drug window 504 includes filtered list of drugs 604 where filtered list of drugs 604 is a subset of drugs included in drug list 506. Each of drugs included in filtered list of drugs 604 may include an associated hyperlink and may be selectable in a manner similar to that described above with respect to drug list 506. In this manner, by providing a graphical user interface that enables a user to select a gene within a pathway and displaying a filtered list of drugs based on the selected gene, a computing device enables a user to select and display a list of drugs for a particular drug in a pathway.

As described above, upon selection of a drug in graphical user interface 500, analysis site 112 and/or computing devices 102A-102N may generate graphical user interfaces based on a selected drug. FIG. 7A-7C are examples of graphical user interfaces that may be provided by a computing device to implement one or more techniques of this disclosure. Graphical user interface 700 is an example of a graphical user interface that enables a user to visualize computed downstream effects of a drug on a given pathway. As illustrated in FIGS. 7A-7C, graphical user interface 700 includes a selected drug 702 and an associated effects table 704, and a modified pathway diagram 706.

In the example illustrated in FIG. 7A, drug A is selected. Table 704 includes an equivalent change in expression level of gene A for drug A (ΔD) and the accumulated perturbation (Acc) for gene A and the total perturbation (TP) and the drug impact factor (IF_{D}) for the pathway. In one example, ΔD may be calculated in a manner similar to that described above with respect to FIG. 3. In other examples, ΔD may be calculated using other techniques. The techniques for generating graphical user interfaces described herein are not limited to a particular technique of calculating ΔD.

As described above, in one example, IF_{D} may be determined by replacing a AE value in equations for determining an impact factor for gene expression changes (IF) with a ΔD value. In a similar manner, accumulated perturbation (Acc) and the total perturbation (TP) may be calculated. It should be noted that the techniques for generating graphical user interfaces described herein are not limited to a particular technique of calculating an impact factor. For example, normalization factors included in Draghici, Tarca and Voichita may be modified when determining a drug impact factor.

As further illustrated in FIG. 7A, modified pathway diagram 706 includes modified interaction symbol 708. In the example illustrated in FIG. 7A, modified interaction symbol 708 may indicate that a predicted downstream effect of drug A on the pathway is gene A failing to activate gene D. That is, the activation indicator illustrated in FIG. 1 is modified from a solid line to a dashed line. It should be noted that indications of predicted downstream effect may be illustrated in graphical user interface 700 using other symbols. For example, an activation indicator may be highlighted, where the color of the highlight indicates a predicted downstream effect (e.g., green enhances an interaction and red inhibits an interaction). In this manner, by providing graphical user interface 700 analysis site 112 and/or computing devices 102A-102N enable a user to visualize computed downstream effect of a selected drug on a pathway.

In the example illustrated in FIG. 7B, drug C is selected and as illustrated in FIG. 7B, modified pathway 706 and table 704 include information based on drug C. In similar manner, modified pathway 706 and table 704 may include information based on drug F, upon selection of drug F. In this manner, graphical user interface 700 may enable a user to prioritize the selection of drug candidates based on putative effects of a given selected gene based on upstream perturbation effects. For example, if a diseased condition is known to prevent gene A from activating gene D, a user may determine whether one or more drugs acting on gene A effect whether gene A activates gene D by selecting a drug and analyzing a corresponding modified pathway 706.

In the example illustrated in FIG. 7C, drug A and drug C are selected and as illustrated in FIG. 7C, modified pathway 706 includes information based on drug A and drug C. By enabling the selection of multiple drugs and displaying a pathway diagram illustrating the effects of each of the selected drugs, potential drug interactions for a given combination therapy involving more than one drug may be identified. Identifying particular drug interactions may be particular useful in the case where a patient is currently taking one type of medication for a condition and a doctor wishes to prescribe another drug for the same or a different condition. In this manner, graphical user interfaces 500, 600, and 700 may enable a researcher to efficiently select one or more candidate drugs from a list of numerous drugs known to act on a pathway.

As described above, a particular gene may be included in multiple pathways. Thus, if a gene included in one pathway is impacted by a drug, the drug may impact another pathway. For example, in the case of the MPAK pathway, the IL1 “gene” is also in the Osteoclast Differentiation pathway. The Gevokizumab drug described above does not appear to have a direct effect on the Osteoclast Differentiation pathway. However, the Anakinra drug, which targets IL1R, does. Thus, in this example, selection between Gevokizumab and Anakinra as a candidate drug may be based on a predicted impact on a pathway other than that intended to be influenced. Impacts on pathways other than a pathway intended to be influenced may be generally described as a possible side-effect of a drug. Thus, the current techniques can be used to identify potential side-effects of specific influences including drugs.

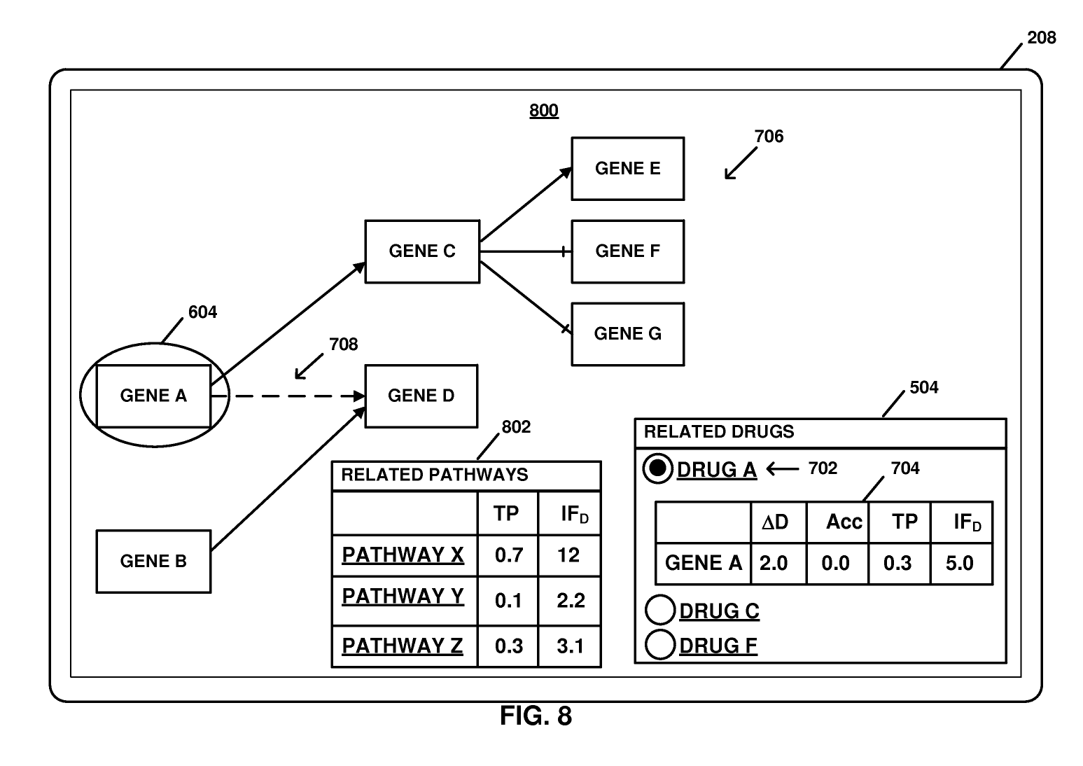

FIG. 8 is an example of a graphical user interface that may be provided by a computing device to implement one or more techniques of this disclosure. Graphical user interface 800 is an example of a graphical user interface that enables a user to identify potential side-effects of a drug. As illustrated in FIG. 8, graphical user interface 800 includes selected drug 702, an associated effects table 704, a modified pathway diagram 706 and related pathway window 802.

Related pathway window 802 may enable a user to predict possible side-effect associated with a particular drug. In the example illustrated in FIG. 8, related pathway window 802 includes a list of pathways that are affected by a selected drug. Further, each pathway included in related pathway 802 includes a hyperlink, the total perturbation (TP), and the drug impact factor (IF_{D}) for the pathway. The total perturbation (TP), and the drug impact factor (IF_{D}) for the pathway may be calculated in a manner similar to that described above with respect to FIGS. 7A-7B. In one example, upon activation of a pathway hyperlink included in related pathway window 802, a graphical user interface illustrating the effects of a drug of the pathway may be generated. That is, modified pathway diagram 706, related drugs window 504, and related pathway window 802 may be updated based on a selected pathway (e.g., pathways are swapped). In this manner, graphical user interface 800 enables a user to identify potential side effects of a drug.

It should be noted that in some instances the number of related pathways may include dozens to hundreds of pathways. In one example, analysis site 112 may be configured to prioritize and/or filter pathways included in related pathway window 802. For example, pathways with a nominal drug impact factor may not be included in related pathway window 802. In one example, a computing device may be configured such that a user can specific a nominal drug impact factor, (e.g., exclude pathways with a drug impact factor less than one). In other examples, pathways included in related pathway window 802 may be filtered based on other criteria.

As described above, gene expression class comparison studies may compare the expression levels of genes of individuals included in one sample group to the expression levels of genes of individuals included in another sample group (e.g. normal and diseased). In one example, analysis site 112 and/or computing devices 102A-102N may process data included in pathway database 106, gene expression database 108, and drug database 110 to predict how a drug may affect an individual and/or sample group with DE genes. Predicting how a drug may affect an individual and/or sample group with specific DE genes may be useful to personalize medicine by combining measured expression levels with a predicted/modeled drug impact. Further, analysis site 112 and/or computing devices 102A-102N may process data included in pathway database 106, gene expression database 108, and drug database 110 to generate graphical user interfaces including gene expression data and drug data.

FIG. 9 is an example of a graphical user interface that may be provided by a computing device to implement one or more techniques of this disclosure. Graphical user interface 900 is an example of a graphical user interface that enables a user to visualize computed downstream effects of a drug on a given system. As illustrated in FIG. 9, graphical user interface 900 includes pathway diagram 902, where pathway diagram includes a selected gene 604 and indicates DE genes (i.e., gene A and gene F) and related drugs window 504, where related drugs window includes selected drug 702 and associated table 704. As further illustrated in FIG. 9, graphical user interface 900 includes differentially expressed genes window 904. Differentially expressed gene window 904 may include data associated with a gene expression class comparison study, as described above with respect with FIG. 2.

As illustrated in FIG. 9, graphical user interface 900 includes an impact factor for a pathway based on gene expression data and an impact factor for a pathway based on drug data. As described above, with respect to FIGS. 7A-7B enabling a user to select different drugs within related drugs window 504 and displaying predicted effects in table 704 and pathway diagram 706 may enable a user to prioritize the selection of drug candidates. The inclusion of DE data in graphical user interface 900 may further enable a user to prioritize the selection of drug candidates and may be particular useful in the case where a user would like to find a drug candidate that ameliorates the impact of one or more DE genes.

As described above, a ΔD(g) value may be used to modify a ΔE(g) value in the impact factor equations described above. For example, if a ΔE(g)=2.0 and a ΔD(g)=−1.0 a value of 1.0 may be used for an effective ΔE(g) value. In one example, it may be desirable to find a drug that causes an effective ΔE(g) value to be zero. Further, in one example, an effective ΔE(g) may be useful in determining a drug dosage. For example, from a controlled phenotype contrast experiment whereby the independent variable is the administration of drug A with dosage X, the ΔD(g) and/or IF on a pathway may be computed for different drug dosages. From this data, an inverse relationship may be computed. That is, given an IF for a pathway based on an observed ΔE(g) value, the probable dosage to achieve a target IF for a pathway may be determined.

As further illustrated in FIG. 9, graphical user interface 900 includes modified interaction symbol 908. Modified interaction symbol 908 may be similar to modified interaction symbol 708 described above. In the example illustrated in FIG. 9, modified interaction symbol 908 may indicate that a predicted downstream effect of drug A on the pathway based on DE gene A. That is, modified interaction symbol 908 may indicate that a drug is predicted to counter a deficiency in gene A due to the fact the gene A is a DE gene.

FIG. 10 is an example of a graphical user interface that may be provided by a computing device to implement one or more techniques of this disclosure. In the example illustrated in FIG. 10, graphical user interface 1000 includes related drugs and expression window 1002 and related pathways window 1006. In a manner similar to related pathway window 802 described above with respect to FIG. 8, related pathway window 1006 includes a list of pathways that are affected by a selected drug. Further, each pathway included in related pathway window 1006 includes a hyperlink, the effective total perturbation (TP_{Eff}), and the effective impact factor (IF_{Eff}) for the pathway, where the effective total perturbation (TP_{Eff}), and the effective impact factor (IF_{Eff}) are calculated based on a ΔE(g) value that has been modified by a ΔD(g) value. Related drugs and expression window 1002 is similar to related drugs window 504 above and enables selection of drugs known to act on a selected gene. Upon a drug in related drugs and expression window 1002 being selected associated table 1004 is displayed.

As illustrated in FIG. 10, table 1004 includes an equivalent change in expression level of gene A for drug A (ΔD), an expression level change value for gene A (ΔE), effective expression level change value (ΔE_{Eff}) for gene A, the effective accumulated perturbation (Acc_{Eff}), the effective total perturbation (TP_{Eff}) and the effective impact factor (IF_{Eff}) for the pathway. The effective values may be calculated based on an equivalent change in expression level of gene A for drug A (ΔD) and an expression level change value for gene A (ΔE). Further, in one example, a ΔD(g) value may be used to modify a ΔE(g) value and the modified value (ΔE_{Eff}) may be used in the impact factor equations described above to determine the effective accumulated perturbation (Acc_{Eff}), the effective total perturbation (TP_{Eff}) and the effective impact factor (IF_{Eff}) for the pathway. In this manner, graphical user interface 1000 represents an example of a graphical user interface that enables the analysis of effects of a drug on a gene signaling pathway.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of modeling effects of a drug on a gene signaling pathway, the method comprising:
receiving topology information associated with a gene signaling pathway;
determining a gene expression level equivalent value for a drug; and
calculating the impact of the drug on the gene signaling pathway based on the received topology information and the determined gene expression level equivalent value.

2. The method of claim 1, wherein receiving topology information associated with a gene signaling pathway includes receiving information indicating respective interactions between genes included in a pathway.

3. The method of claim 1, wherein a drug includes one of a synthetic composition, a biologic, DNA (gene therapy), and an mRNA.

4. The method of claim 1, wherein determining a gene expression level equivalent value for a drug includes determining the gene expression level equivalent value for the drug based on an expression value change determined from a class comparison study.

5. The method of claim 1, wherein determining a gene expression level equivalent value for a drug includes determining the gene expression level equivalent value for the drug based on an observed expression value of a drug treatment study.

6. The method of claim 1, wherein calculating the impact of the drug on the gene signaling pathway includes determining an impact factor.

7. The method of claim 6, wherein determining an impact factor includes determining an impact factor based on a sum of a perturbation factors for genes in a pathway.

8. The method of claim 1, further comprising receiving topology information associated with one or more additional gene signaling pathways and calculating the impact of the drug on the one or more additional gene signaling pathways.

9. The method of claim 8, wherein calculating the impact of the drug on the one or more additional gene signaling pathways includes identifying side effects associated with the drug.

10. The method of claim 1, further comprising determining gene expression level equivalent values for one or more additional drugs and calculating the impact of the one or more additional drugs on the gene signaling pathway based on the received topology information and the determined gene expression level equivalent values.

11. The method of claim 1, wherein calculating the impact of the one or more additional drugs on the gene signaling pathway based on the received topology information and the determined gene expression level equivalent values includes identifying drug interactions.

12. A method of modeling effects of a drug on a gene signaling pathway, the method comprising:
receiving topology information associated with a gene signaling pathway;
receiving differentially expressed gene data;
determining a gene expression level equivalent value for a drug; and
calculating an effective impact of the drug on the gene signaling pathway based on the received topology information, the received differentially expressed gene data, and the determined gene expression level equivalent value.

13. The method of claim 12, wherein receiving topology information associated with a gene signaling pathway includes receiving information indicating respective interactions between genes included in a pathway.

14. The method of claim 12, wherein a drug includes one of a synthetic composition, a biologic, DNA (gene therapy), and an mRNA.

15. The method of claim 12, wherein determining a gene expression level equivalent value for a drug includes determining the gene expression level equivalent value for the drug based on an expression value change determined from a class comparison study.

16. The method of claim 12, wherein determining a gene expression level equivalent value for a drug includes determining the gene expression level equivalent value for the drug based on an observed expression value of drug treatment study.

17. The method of claim 12, wherein calculating the impact of the on the gene signaling pathway includes determining an impact factor.

18. The method of claim 17, wherein determining an impact factor includes determining an impact factor based on a sum of a perturbation factors for genes in a pathway.

19. A method for enabling the analysis of effects of a drug on a gene signaling pathway, the method comprising:
receiving a gene signaling pathway selection;
receiving differentially expressed gene data; and
providing a graphical user interface including a pathway diagram of the selected pathway, differentially expressed gene data, and a list of drugs known to act on the selected pathway.

20. The method of claim 19, wherein the graphical user interface enables selection of a gene included in the pathway diagram, and upon selection of a gene, filtering the list of drugs known to act on the pathway to a list of drugs known to act on the selected gene.

21. The method of claim 20, wherein the graphical user interface enables selection of a drug, and upon selection of a drug displaying calculated drug effect information, wherein displaying calculated drug effect information includes displaying an effective impact factor.

22. The method of claim 20, wherein displaying calculated drug effect information includes displaying a modified interaction symbol in conjunction with the pathway diagram.
